(19) United States
(12) Patent Application Publication
(10) Pub. No.: US 2011/0298597 A1
(43) Pub. Date: Dec. 8, 2011

(54) WIRELESS SENSOR SYSTEM

(75) Inventors: Hiroki KAIHORI, Osaka (JP); Eiji Miyake, Kyoto (JP); Michiaki Tsuneoka, Osaka (JP)

(73) Assignee: Panasonic Corporation, Osaka (JP)

(21) Appl. No.: 13/150,533

(22) Filed: Jun. 1, 2011

(30) Foreign Application Priority Data
Jun. 2, 2010 (JP) JP 2010-126485

(51) Int. Cl. G08C 19/12

(52) U.S. Cl. 340/13.25

(57) ABSTRACT

A wireless sensor system includes a wireless sensor, a wireless device, and a magnetic field generator connected to the wireless device. The wireless sensor includes an ambience sensor that detects status of an ambient environment to output ambient data depending on the detected status of the ambient environment, a magnetic sensor that senses a magnetic field, a radio-frequency (RF) transmitter that sends the ambient data to the wireless device using a radio wave, and a first controller that is connected to the ambience sensor, the magnetic sensor, and the RF transmitter. The wireless device includes an RF receiver that receives the radio wave sent from the RF transmitter; and a second controller that is connected to the RF receiver and that outputs a control signal for controlling the first controller. The magnetic field generator includes a coil for sending the control signal to the magnetic sensor using a magnetic field.

### FIELD OF THE INVENTION

The present invention relates to a wireless sensor system that includes a wireless device and a small wireless sensor for detecting the status of an ambient environment.

### BACKGROUND OF THE INVENTION

FIG. 5 is a block diagram of conventional wireless system 501 disclosed in Japanese Patent Laid-Open Publication No. 2009-239551. Wireless system 501 includes audio input/output unit 130, wireless device body 110; wireless device 100, and control unit 140. Wireless device body 110 sends or receives audio signal SV1 to or from wireless device 100 by wireless communication method CM1 with using a radio wave.

Wireless transceiver 120 of wireless device body 110 employs wireless communication method CM2, such as the Bluetooth™ or a spread spectrum method, with using a radio wave to send and receive audio signal SV2 to and from audio transceiver 131 of audio input/output unit 130 and to send and receive control signal SC to and from control unit 140.

Audio input/output unit 130 includes audio transceiver 131, microphone 132, earphone 133, and battery 130A for driving them. Audio transceiver 131 employs wireless communication method CM2 to send an audio signal input from microphone 132 to wireless transceiver 120 and outputs, to earphone 133, an audio signal received from wireless transceiver 120.

Audio input/output unit 130 has large power consumption, and increases the size of battery 130A accordingly, thus being prevented from having a small size.

### SUMMARY OF THE INVENTION

A wireless sensor system includes a wireless sensor configured to be driven by a battery, a wireless device, and a magnetic field generator connected to the wireless device. The wireless sensor includes an ambience sensor that detects a status of an ambient environment to output ambient data depending on the detected status of the ambient environment, a magnetic sensor that senses a magnetic field, a radio-frequency (RF) transmitter that sends the ambient data to the wireless device with using a radio wave, and a first controller that is connected to the ambience sensor, the magnetic sensor, and the RF transmitter. The wireless device includes an RF receiver that receives the radio wave sent from the RF transmitter; and a second controller that is connected to the RF receiver and that outputs a control signal for controlling the first controller. The magnetic field generator includes a coil for sending the control signal to the magnetic sensor with using a magnetic field.

This wireless sensor system can reduce power consumption to allow the battery to have a small size, accordingly allowing the wireless sensor to be small.

### BRIEF DESCRIPTION OF THE DRAWINGS

FIG. 1 is a block diagram of a wireless sensor system according to Exemplary Embodiment 1 of the present invention.

FIG. 2 is a perspective view of the wireless sensor system shown in FIG. 1.

FIG. 3 is a block diagram of a wireless sensor system according to Exemplary Embodiment 2 of the invention.

FIG. 4 is a perspective view of the wireless sensor system shown in FIG. 3.

FIG. 5 is a block diagram of a conventional wireless system.

### DETAILED DESCRIPTION OF PREFERRED EMBODIMENTS

### Exemplary Embodiment 1

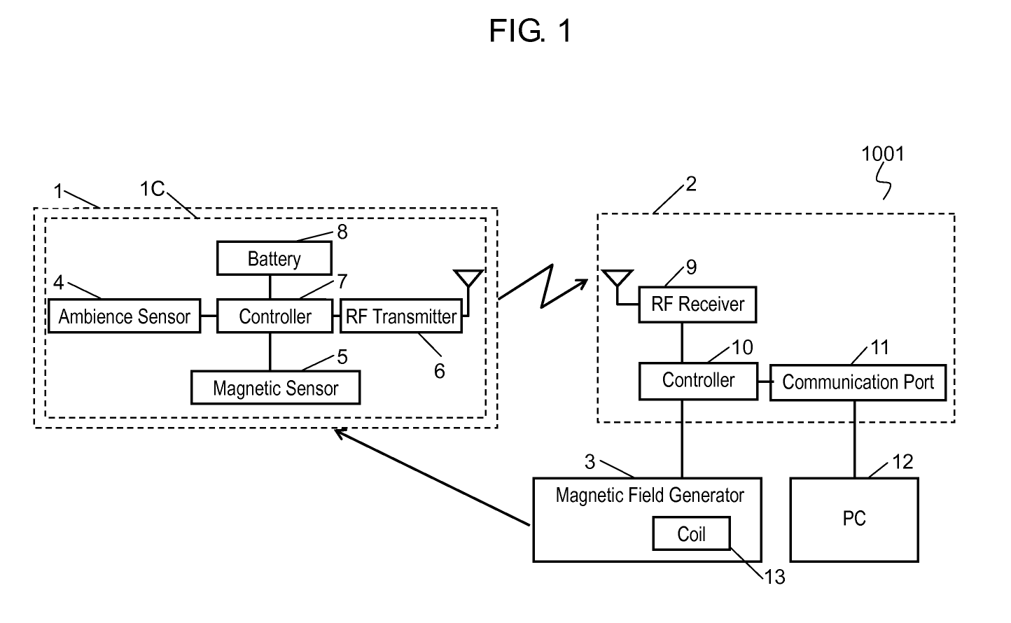

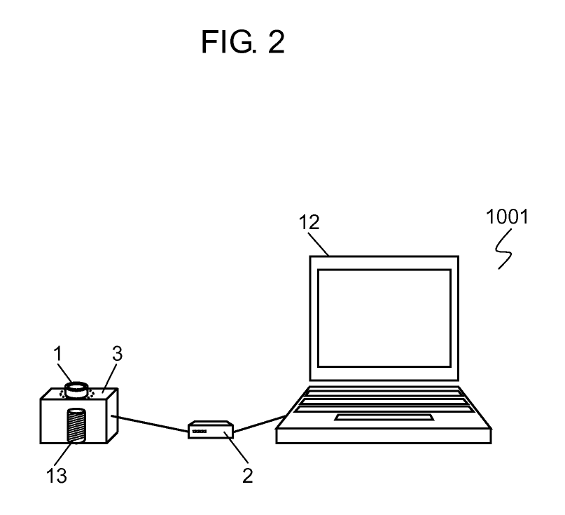

FIGS. 1 and 2 are a block diagram and a perspective view of wireless sensor system 1001 according to Exemplary Embodiment 1 of the present invention, respectively. Wireless sensor system 1001 includes wireless sensor 1, wireless device 2, and magnetic field generator 3.

Wireless sensor 1 includes: ambience sensor 4 for detecting the status of an ambient environment, magnetic sensor 5 for sensing a magnetic field, radio-frequency (RF) transmitter 6 for transmitting to wireless device 2, as a radio wave, the status of the ambient environment detected by ambience sensor 4, controller 7 connected to ambience sensor 4, magnetic sensor 5, and RF transmitter 6, and battery 8 for supplying electric power to ambience sensor 4, magnetic sensor 5, RF transmitter 6, and controller 7. Case 1C accommodates therein ambience sensor 4, magnetic sensor 5, RF transmitter 6, controller 7, and battery 8.

Wireless device 2 includes RF receiver 9 for receiving the radio wave transmitted from RF transmitter 6, controller 10 connected to RF receiver 9, and communication port 11 connected to controller 10. Communication port 11 sends and receives data to and from personal computer (PC) 12.

Magnetic field generator 3 is connected to controller 10 and includes coil 13 for converting a signal from controller 10 to magnetic field and sending the magnetic field to magnetic sensor 5.

Ambience sensor 4 is a sensor, such as a thermal sensor, a contact-type or noncontact-type temperature sensor, an optical sensor, a magnetic sensor, an audio sensor, a concentration sensor for an ion concentration or gas concentration, a displacement sensor, a rotation sensor, a position sensor, a speed sensor, an angular velocity sensor, an acceleration sensor, a humidity sensor, or an odor sensor. Ambience sensor 4 outputs ambient data according to the status of the ambient environment of ambience sensor 4, such as heat, temperature, light, magnetic field, sound, an ion concentration, a gas concentration, a displacement, a rotation number, a position, a speed, an angular velocity, acceleration, humidity, or odor.

Magnetic sensor 5 may be a reed switch that operates in a specific magnetic field or a Hall element for detecting a magnetic field.

RF transmitter 6 may be a wireless device that employs a communication method, such as a wireless LAN or the Bluetooth™, for exchanging signals with using a radio wave.

Controller 7 is implemented by a single-chip microcomputer that operates selectively in a normal power consumption mode in which controller 7 operates with a high operating frequency and in a low power consumption mode in which controller 7 operates with a low operating frequency so that controller 7 consumes lower power in low power consumption mode than in the normal power consumption. Controller 7 may include a ROM storing therein a program for operating wireless sensor 1, a storage section, such as RAM or a flash memory, used to execute the program, and a CPU for controlling wireless sensor 1 based on the program.

Battery 8 may be a button-type battery or a coin-type battery.

RF receiver 9 is a wireless device for receiving a signal sent by a communication method, such as a wireless LAN or the Bluetooth™, with using a radio wave

Controller 10 may be implemented by a single-chip microcomputer. Controller 10 may include: a ROM for storing therein a program for operating wireless sensor 1, wireless device 2, and magnetic field generator 3; a storage section, such as a RAM or a flash memory, used to execute the program, and a CPU for controlling wireless device 2 based on the program.

Communication port 11 may be a wired communication device that can communicate with PC 12 by a wired communication method, such as USB or IEEE1394, or a wireless communication device that can communicate with PC 12 by a wireless communication method, such as a wireless LAN or Bluetooth™

PC 12 may be a Windows™ PC including a display, a Linux PC, a mobile phone, or a mobile terminal.

Coil 13 may be an air core coil, a core coil, or a toroidal coil.

In wireless sensor system 1001 shown in FIG. 1, magnetic field generator 3 is connected to controller 10. Magnetic field generator 3 may be configured so that magnetic field generator 3 can be separated from controller 10. Wireless sensor system 1001 can have a small size when being used for a unidirectional communication from wireless sensor 1 to wireless device 2.

An operation of wireless sensor system 1001 will be described below. In this description, ambience sensor 4 is a temperature sensor that detects a temperature around ambience sensor 4.

When battery 8 is installed and connected to wireless sensor 1, controller 7 operates in the low power consumption mode in order to reduce the power consumption in battery 8. In the low power consumption mode of controller 7, the power consumption can be reduced by reducing the operating frequency of controller 7. Controller 7 prevents battery 8 from supplying electric power to ambience sensor 4 and RF transmitter 6 to prevent ambience sensor 4 and RF transmitter 6 from operating. In the low power consumption mode, controller 7 periodically activates magnetic sensor by a predetermined time interval to confirm whether magnetic sensor 5 receives a magnetic field or not. Even when magnetic sensor 5 is activated, controller 7 prevents battery 8 from supplying electric power to ambience sensor 4 and RF transmitter 6 to prevent ambience sensor 4 and RF transmitter 6 from operating. Ambience sensor 4 and RF transmitter 6 do not operate, and significantly reduces power consumption of wireless sensor 1.

When a user using wireless sensor system 1001 sends activation request data for activating wireless sensor 1 through PC 12, controller 10 receives the activation request data via communication port 11. In response, controller 10 drives coil 13 of magnetic field generator 3 to send an activation request signal with using a magnetic field. The activation request signal is a control signal for controlling controller 7 of wireless sensor 1.

In wireless sensor 1, when controller 7 confirms that the magnetic field sent from coil 13 is received by magnetic sensor 5, controller 7 confirms whether a signal can be received or not. If the received magnetic signal is the activation request signal, controller 7 shifts to the normal power consumption mode to operate in the normal power consumption mode. Then, controller 7 sends, to wireless device 2 with using a radio wave, an acknowledgement signal indicating an acknowledgement of the activation request signal from RF transmitter 6. After the acknowledgement signal is transmitted to wireless device 2, controller 7 shifts to the low power consumption mode and periodically activates magnetic sensor 5 with a predetermined time interval to confirm whether magnetic sensor 5 receives a magnetic field or not. When the received magnetic signal is not the activation request signal, controller 7 periodically activates magnetic sensor 5 with a predetermined time interval in the low power consumption mode to confirm whether magnetic sensor 5 receives a magnetic field or not.

In the normal power consumption mode, controller 7 operates at a higher operating frequency than in the low power consumption mode to provide a higher processing speed. Specifically, in the normal power consumption mode, controller 7 operates with higher power consumption than in the low power consumption mode.

In wireless device 2, when RF receiver 9 receives the acknowledgement signal from wireless sensor 1, controller 10 sends the acknowledgement signal to PC 12 via communication port 11.

Upon receiving the acknowledgement signal, PC 12 displays, on a display thereof, an indication indicating that wireless sensor 1 has received the activation request signal.

Ambience sensor 4 detects the temperature around ambience sensor 4. In order to execute an operation to send temperature data indicating the detected temperature from wireless sensor 1 to wireless device 2 with a predetermined time interval, the user operates PC 12 to send start request data for starting this operation to controller 10 via communication port 11. Upon receiving the start request data via communication port 11, controller 10 drives coil 13 of magnetic field generator 3 to send a start request signal to magnetic sensor 5 with using a magnetic field. The start request signal is a control signal for controlling controller 7 of wireless sensor 1.

In wireless sensor 1, when controller 7 confirms that the magnetic field sent from coil 13 is received by magnetic sensor 5, controller 7 confirms whether a signal can be received or not. When the received magnetic field signal is the start request signal, controller 7 shifts from the low power consumption mode to the normal power consumption mode to operate in the normal power consumption. Then, controller 7 drives ambience sensor 4 to detect the temperature. Next, controller 7 drives RF transmitter 6 to send the temperature data indicating the temperature to wireless device 2 with using a radio wave. When a predetermined time interval elapses after the transmission of the temperature data, controller 7 drives ambience sensor 4 to detect the temperature. Next, controller 7 drives RF transmitter 6 to send the temperature data indicating the temperature to wireless device 2 with using a radio wave. Thus, controller 7 transmits the temperature data repetitively, that is, causes RF transmitter 6 to periodically transmit the temperature data to wireless device 2 with the predetermined time interval.

In the above-described operation, after the transmission of the temperature data, controller 7 may shift to the low power consumption mode to operate in the low power consumption mode. When the predetermined time interval elapses after the shifting to the low power consumption mode, controller 7 shifts to the normal power consumption mode to operate in the normal power consumption mode, and drives ambience sensor 4 to detect the temperature. Next, controller 7 drives RF transmitter 6 to send temperature data indicating the temperature to wireless device 2 with using a radio wave. Thus, controller 7 repeats the operation in the low power consumption and the transmission of the temperature data in the normal power consumption mode, and causes RF transmitter 6 to periodically send the temperature data to wireless device 2 with a predetermined time interval with using the radio wave, thereby reducing the power consumption of wireless sensor 1.

In wireless device 2, the radio wave of the temperature data periodically sent from wireless sensor 1 is received by RF receiver 9. Then, controller 10 sends the temperature data to PC 12 via communication port 11. Then, PC 12 periodically displays, on the display thereof, the value of the temperature indicated by the temperature data sent from wireless device 2.

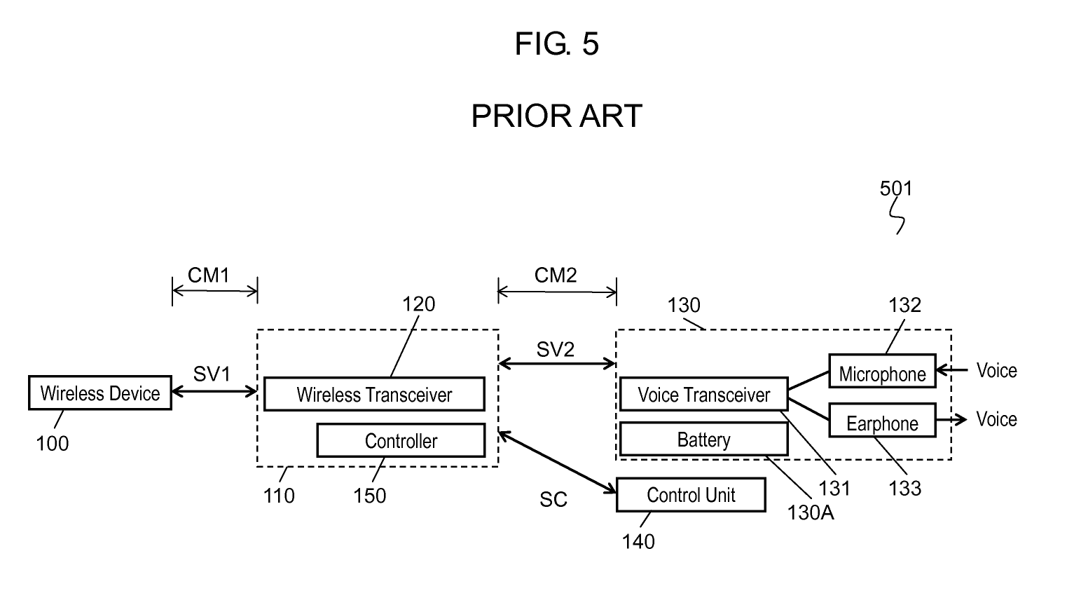

In conventional wireless system 501 shown in FIG. 5, wireless device body 110 and audio input/output unit 130 uses communication methods CM1 and CM2 with using a radio wave for both of transmission and reception. Thus, audio input/output unit 130 having large power consumption requires battery 130A to have a large size. Thus, audio input/output unit 130 has a difficulty in downsizing.

In wireless sensor system 1001 according to Embodiment 1 shown in FIGS. 1 and 2, on the other hand, signal transmission from wireless device 2 to wireless sensor 1 is carried out not with using the radio wave requiring high power consumption but with using the magnetic field sent to magnetic sensor 5. This operation reduces power consumption to reduce the size of battery 8, thus providing wireless sensor 1 with a small size.

RF transmitter 6 heterodynes the temperature data indicating the temperature detected by ambience sensor 4 so that the data can have a frequency that can be used for wireless communication. On the other hand, the signal sent from coil 13 is a baseband digital signal which is not heterodyned. Thus, magnetic sensor 5 does not include a circuit for the heterodyning, thus providing wireless sensor 1 with a small size.

The wireless communication between coil 13 and magnetic sensor 5 is carried out by a near-field communication, such as electromagnetic induction using a magnetic field. This communication is carried out in a region for which the signal strength is independently influenced by a term that is inversely proportional to the square and the cube of the distance between coil 13 and magnetic sensor 5. This consequently prevents a distant signal from leaking and prevents even a digital signal from functioning as a noise to an external device.

In the case that the temperature detecting by ambience sensor 4 of wireless sensor 1 and the transmission of a radio wave from the RF transmitter are periodically executed with a predetermined time interval, controller 10 may send a time interval change request signal for changing the time interval via coil 13 to wireless sensor 1 with using a magnetic field. This signal can increase the predetermined time interval, thereby reducing the power consumption of battery 8. This signal can decrease the predetermined time interval to allow PC 12 to accurately display the temperature change when the temperature changes within a short time.

A temperature correction data writing request signal for writing temperature correction data to wireless sensor 1 also may be sent from controller 10 via coil 13 to wireless sensor 1 with using a magnetic field. If this signal is received by magnetic sensor 5 of wireless sensor 1, controller 7 writes the temperature correction data to the RAM provided therein for storage. The RAM may be substituted with a flash memory or an external EEPROM. Based on the stored temperature correction data, controller 7 corrects the temperature data indicating the temperature detected by ambience sensor 4 and transmits the corrected temperature data from RF transmitter 6 with using a radio wave. This operation allows PC 12 to display an accurate temperature value without the correction of the temperature data by PC 12. The temperature correction data writing request signal is a control signal for controlling controller 7 of wireless sensor 1.

A temperature correction data reading request signal for reading the temperature correction data stored in controller 7 from wireless sensor 1 may be sent from controller 10 via coil 13 to wireless sensor 1 with using a magnetic field. When magnetic sensor 5 of wireless sensor 1 receives the temperature correction data reading request information, controller 7 transmits the stored temperature correction data from RF transmitter 6 to wireless device 2 with using a radio wave. Wireless device 2 can read the temperature correction data from the RAM provided in controller 7. The RAM may be substituted with a flash memory or an external EEPROM. The temperature correction data reading request signal is a control signal for controlling controller 7 of wireless sensor 1.

The frequency of a radio wave transmitted from RF transmitter 6 of wireless sensor 1 may change according to a temperature. In controller 10, a flash memory previously stores a change of the frequency received by RF transmitter 6 to a temperature. Controller may read a change of the frequency of the RF transmitter 6 stored in controller 10 according to the temperature data received by RF receiver 9, and change, based on the read change of the frequency, the frequency of the radio wave received by RF receiver 9. This consequently allows RF receiver 9 to receive the temperature data even when RF transmitter 6 has a changed transmission frequency.

As described above, A wireless sensor system includes wireless sensor 1 configured to be driven by battery 8, wireless device 2, and magnetic field generator 3 connected to wireless device 2. Wireless sensor 1 includes ambience sensor 4, magnetic sensor 5, RF transmitter 6, and controller 7. Ambience sensor 4 detects a status of an ambient environment to output ambient data depending on the detected status of the ambient environment. Magnetic sensor 5 receives electric power supplied from battery 8 to sense a magnetic field. RF transmitter 6 that receives electric power supplied from battery 8 to send the ambient data to the wireless device with using a radio wave. Controller 7 receives electric power supplied from battery 8, and is connected to ambience sensor 4, magnetic sensor 5, and RF transmitter 6. Wireless device 2 includes RF receiver 9 and controller 10. RF receiver 9 receives the radio wave sent from RF transmitter 6. Controller 10 is connected to RF receiver 9 and outputs a control signal for controlling controller 7. Magnetic field generator 3 includes coil 13 for sending the control signal to magnetic sensor 5 with using a magnetic field. The ambient environment detected by ambience sensor 4 includes a temperature.

Magnetic field generator 3 can be separated from controller 10 of wireless device 2.

Controller 7 of wireless sensor 1 stores correction data for correcting the ambient data. RF transmitter 6 of wireless sensor 1 can transmit the corrected ambient data with using the radio wave. The correction data can be written in controller 7 of wireless sensor 1. The correction data can be read from controller 7 of wireless sensor 1.

### Exemplary Embodiment 2

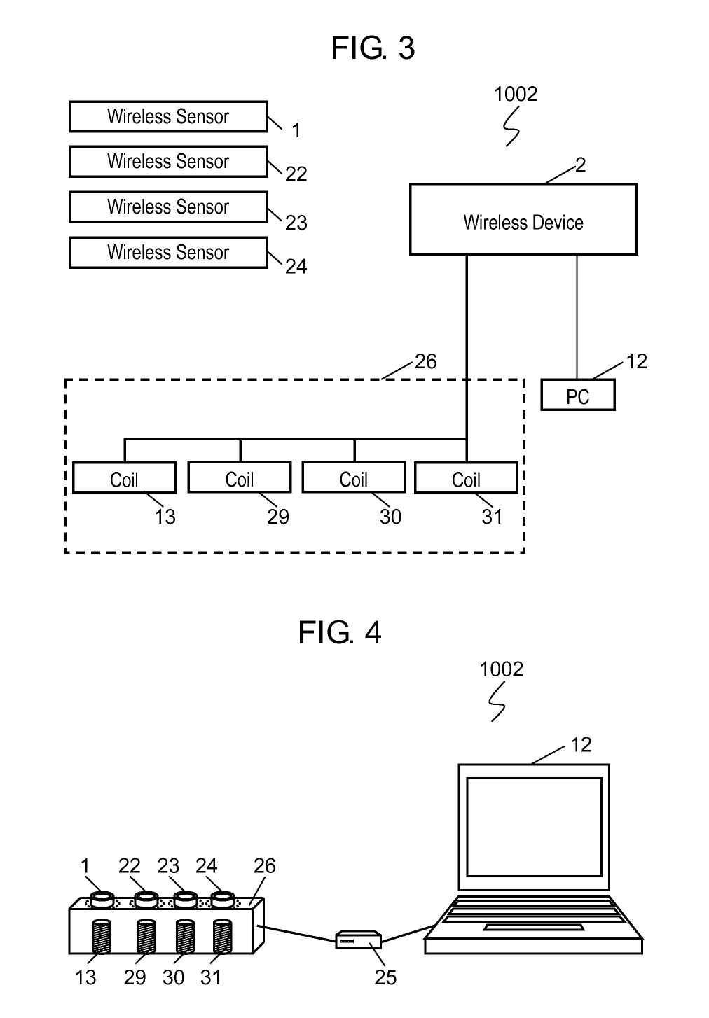

FIGS. 3 and 4 are a block diagram and a perspective view of wireless sensor system 1002 according to Exemplary Embodiment 2 of the present invention, respectively. In FIGS. 3 and 4, components identical to those of wireless sensor system 1001 shown in FIGS. 1 and 2 are denoted by the same reference numerals.

Wireless sensor system 1002 according to Embodiment 2 includes magnetic field generator 26 instead of magnetic field generator 3 of wireless sensor system 1001 according to Embodiment 1, and includes wireless sensors 1, 22, 23, and 24 with respect to one wireless device 2. Magnetic field generator 26 includes coils 13, 29, 30, and 31. Similarly to wireless sensor 1 shown in FIG. 1, each of wireless sensors 22 to 24 includes ambience sensor 4 for detecting the status of an ambient environment, magnetic sensor 5 for sensing a magnetic field, radio-frequency (RF) transmitter 6 for transmitting, to wireless device 2 as a radio wave, the status of the ambient environment detected by ambience sensor 4, controller 7 connected to ambience sensor 4, magnetic sensor 5, and RF transmitter 6, and battery 8 for supplying electric power to ambience sensor 4, magnetic sensor 5, RF transmitter 6, and controller 7. Wireless sensors 1, 22, 23, and 24 are positioned near coils 13, 29, 30, and 31, respectively.

Each of wireless sensors 1, 22, 23, and 24 periodically transmits temperature data as a radio wave with a predetermined time interval. In the case that the predetermined time interval is one second, wireless sensor 22 transmits the temperature data as a radio wave to wireless device 2 after the duration of 250 ms elapses after the start of the transmission by wireless sensor 1 of the temperature data as a radio wave to wireless device 2 so as to prevent at least two of wireless sensors 1, 22, 23, and 24 from simultaneously transmitting the temperature data. In this case, wireless sensor 1 transmits the temperature data as a radio wave to wireless device 2 for a period shorter than 250 ms. Specifically, wireless sensor 1 terminates the transmission of the temperature data by the start of the transmission to wireless device 2 by wireless sensor 22 of the temperature data as a radio wave. After the duration of 250 ms elapses after the start of the transmission of the temperature data as a radio wave from wireless sensor 22 to wireless device 2, wireless sensor 23 starts the transmission of the temperature data as a radio wave to wireless device 2. Then, wireless sensor 22 sends the temperature data as a radio wave to wireless device 2 for a period shorter than 250 ms. Specifically, wireless sensor 22 terminates the transmission of the temperature data by the start of the transmission of the temperature data from wireless sensor 23 to wireless device 2 as a radio wave. After the duration of 250 ms elapses after the start of the transmission of the temperature data as a radio wave from wireless sensor 23 to wireless device 2, wireless sensor 24 starts the transmission of the temperature data as a radio wave to wireless device 2. Then, wireless sensor 23 sends the temperature data as a radio wave to wireless device 2 for a period shorter than 250 ms. Specifically, wireless sensor 23 terminates the transmission of the temperature data by the start of the transmission of the temperature data from wireless sensor 24 to wireless device 2 as a radio wave. After the duration of 250 ms elapses after the start of the transmission of the temperature data as a radio wave from wireless sensor 24 to wireless device 2, wireless sensor 1 starts the transmission of the temperature data as a radio wave to wireless device 2. Then, wireless sensor 24 sends the temperature data as a radio wave to wireless device 2 for a period shorter than 250 ms. Specifically, wireless sensor 24 terminates the transmission of the temperature data by the start of the transmission to wireless device 2 by wireless sensor 1 of the temperature data as a radio wave.

When the user executes an activation request for coil 13 through PC 12, controller 10 of wireless device 2 (FIG. 1) causes wireless sensor 1 positioned near coil 13 to send an activation request signal through coil 13 with using a magnetic field. Upon receiving the activation request signal for coil 29 from PC 12, controller 10 causes wireless sensor 22 positioned near coil 29 to transmit an activation request signal through coil 29 with using a magnetic field. Similarly, controller 10 sends an activation request signal to wireless sensors 23 and 24 via coils 30 and 31 with using a magnetic field, respectively.

Next, when the user executes a start request through PC 12, controller 10 of wireless device 2 causes coil 13 to send a start request signal with using a magnetic field. Then, the start request signal is received by wireless sensor 1 positioned near coil 13, thus starting the transmission of the temperature data to wireless device 2 with using a radio wave repetitively with a predetermined time interval of one second. After the duration of 250 ms elapses after the start of the transmission of the start request signal through coil 13, controller 10 causes coil 29 to send a start request signal with using a magnetic field. The start request signal is received by wireless sensor 22 positioned near coil 29, thus starting the transmission of the temperature data with using a radio wave repetitively at a predetermined time interval of one second. Similarly, controller 10 causes coils 30 and 31 to send a start request signal with using a magnetic field. This operation allows four wireless sensors 1, 22, 23, and 24 to send, to wireless device 2 with using a radio wave, the temperature data for one second such that the transmission by each of four wireless sensors 1, 22, 23, and 24 is delayed by an equal time interval of 250 ms, thereby sending the temperature data from wireless sensors 1, 22, 23, and 24 to PC 12. This operation prevents four wireless sensors 1, 22, 23, and 24 from sending the temperature data simultaneously with using a radio wave, thus eliminating the need for retransmission to thereby achieve electric power saving. The start request signal is a control signal for controlling controller 7 of each of wireless sensors 1, 22, 23, and 24.

Similarly to wireless sensor system 1001 according to Embodiment 1, wireless sensor system 1002 according to Embodiment 2 is configured so that RF transmitter 6 of each of wireless sensors 1, 22, 23, and 24 (see FIG. 1) has a circuit for performing heterodyning. However, signals sent through coils 13, 29, 30, and 31 are baseband digital signals which are not heterodyned.

Thus, wireless sensors 1, 22, 23, and 24 may not include a circuit for heterodyning, thus providing wireless sensors 1, 22, 23, and 24 with a small size.

In the case that the time from the transmission of temperature data by each of wireless sensors 1, 22, 23, and 24 with using a radio wave to the transmission of the next transmission data with using a radio wave is long, controller 7 of each of wireless sensors 1, 22, 23, and 24 shifts to the low power consumption mode after sending the temperature data. In this case, after a predetermined time interval elapses, controller 7 shifts from the low power consumption mode to the normal power consumption mode to operate in the normal power consumption mode to cause ambience sensor 4 to detect the temperature to output the temperature data. Then, controller 7 causes RF transmitter 6 to transmit the temperature data to wireless device 2 with using a radio wave. After the predetermined time interval elapses after the transmission of the temperature data, controller 7 shifts from the normal power consumption mode to the low power consumption mode to operate in the low power consumption mode. Thus, controller 7 repeats the operation in the low power consumption mode and the transmission of the temperature data in the normal power consumption mode alternately. RF transmitter 6 thus periodically transmits the temperature data to wireless device 2 at the predetermined time interval, hence reducing power consumption of wireless sensors 1, 22, 23, and 24.

Furthermore, the wireless communication between coil 13 and wireless sensor 1, the wireless communication between coil 29 and wireless sensor 22, the wireless communication between coil 30 and wireless sensor 23, and the wireless communication between coil 31 and wireless sensor 24 shown in FIG. 4 are carried out by a near-field communication, such as electromagnetic induction using a magnetic field. This communication is carried out in a region for which the signal strength is independently influenced by a term that is inversely proportional to the square and the cube of the distance between coil 13 (29 to 31) and magnetic sensor 5. This consequently prevents a distant signal from leaking and prevents even a digital signal from being noise to an external device. Therefore, the magnetic field of coil 13 cannot be received by wireless sensor 22 positioned adjacent to coil 29 with a large intensity, hence providing magnetic field generator 26 with a small size.

Similarly to Embodiment 1, magnetic field generator 26 may be configured so that magnetic field generator 26 can be separated from wireless device 2. In the case that wireless sensors 1, 22, 23, and 24 are used in wireless sensor system 1002 according to Embodiment 2, magnetic field generator 26 requires coils 13, 29, 30, and 31, thus requiring a larger size than that of magnetic field generator 3 according to Embodiment 1. This means that a higher effect can be obtained by the downsizing of wireless device 2 by separating magnetic field generator 26 from wireless device 2.

As described above, wireless sensors 1, 22, 23, and 24 send signals to wireless device 2 with using a radio wave. Controller 10 of wireless device 2 outputs control signals for controlling wireless sensors 1, 22, 23, and 24. Magnetic field generator 26 includes coils 13, 29, 30, and 31 for sending the control signals to wireless sensor 2 with using a magnetic field.

Magnetic field generator 26 sequentially and periodically sends control signals at a predetermined time interval to wireless sensors 1, 22, 23, and 24 with using a magnetic field.

In the present invention, the term “connection” means electrical connection including not only wired connection but also electromagnetic connection.

As described above, wireless sensor systems 1001 and 1002 of Embodiments 1 and 2 has low power consumption, to reduce power consumption in battery 8, accordingly providing battery with a small size. Thus, wireless sensor systems 1001 and 1002 can be used for, e.g. a small wireless temperature sensor system or a biological body sensor system.

What is claimed is:

1. A wireless sensor system comprising:
a first wireless sensor configured to be driven by a battery;
a wireless device; and
a magnetic field generator connected to the wireless device,
wherein the first wireless sensor includes:
an ambience sensor that detects a status of an ambient environment to output ambient data depending on the detected status of the ambient environment;
a magnetic sensor that receives electric power supplied from the battery to sense a magnetic field;
a radio-frequency (RF) transmitter that receives electric power supplied from the battery to send the ambient data to the wireless device with using a radio wave; and
a first controller that receives electric power supplied from the battery and that is connected to the ambience sensor, the magnetic sensor, and the RF transmitter,
wherein the wireless device includes:
an RF receiver that receives the radio wave sent from the RF transmitter; and
a second controller that is connected to the RF receiver and that outputs a first control signal for controlling the first controller, and
wherein the magnetic field generator includes a first coil for sending the first control signal to the first magnetic sensor with using a magnetic field.

2. The wireless sensor system according to claim 1, wherein: the magnetic field generator can be separated from the second controller of the wireless device.

3. The wireless sensor system according to claim 1,
wherein the wireless sensor system further includes a second wireless sensor that sends a signal to the wireless device with using a radio wave,
wherein the second controller of the wireless device outputs a second control signal for controlling the second wireless sensor, and
wherein the magnetic field generator further includes a second coil for sending the second control signal to the second wireless sensor with using a magnetic field.

4. The wireless sensor system according to claim 3, wherein the magnetic field generator sequentially and periodically sends the first control signal and the second control signal at a predetermined time interval to the first wireless sensor and the second wireless sensor, respectively, with using a magnetic field.

5. The wireless sensor system according to claim 1,
wherein: the first controller of the first wireless sensor stores correction data for correcting the ambient data, and
wherein the RF transmitter of the first wireless sensor sends the corrected ambient data with using the radio wave.

6. The wireless sensor system according to claim 5, wherein: the correction data can be written in the first controller of the first wireless sensor.

7. The wireless sensor system according to claim 6, wherein: the correction data can be read from the first controller of the first wireless sensor.

8. The wireless sensor system according to claim 5, wherein: the correction data can be read from the first controller of the first wireless sensor.

9. The wireless sensor system according to claim 1, wherein the ambient environment detected by the ambience sensor includes a temperature.
